(19) United States
(12) Patent Application Publication
(10) Pub. No.: US 2020/0130506 A1
(43) Pub. Date: Apr. 30, 2020

(54) FEED MIXER DRIVETRAIN PROVIDED WITH A TRANSMISSION AND CONTROL METHOD THEREFOR

(71) Applicant: TRANSMISSION CVTCORP INC., Québec (CA)

(72) Inventors: Michel-Xavier DUMAIS, Québec (CA); Jonathan GUÉRIN, Québec (CA); Jeremy SHIFLETT, Lafayette, IN (US); Jean-Francois DIONNE, Québec (CA); Daniel GIRARD, Québec (CA)

(73) Assignee: TRANSMISSION CVTCORP INC., Québec, QC (CA)

(21) Appl. No.: 16/483,544

(22) PCT Filed: Jan. 30, 2018
(86) PCT No.: PCT/CA2018/050105

§ 371 Date: Aug. 5, 2019

Related U.S. Application Data
(60) Provisional application No. 62/456,925, filed on Feb. 9, 2017.

(51) Int. Cl. B60K 17/28; B60W 10/06

(52) U.S. Cl. CPC B60K 17/28; A01K 5/001; B60W 10/06

(57) ABSTRACT

A Feed Mixer Drivetrain provided with a transmission and control method therefor, wherein a controller is so configured as control a sequence of operation phases of the feed mixer; each operation phase defining a predetermined speed of the input shaft of the feed mixer via the transmission and a predetermined duration.

### FIELD

The present disclosure generally relates to feed mixer drivetrains. More specifically, the present disclosure is concerned with a feed mixer drivetrain provided with a transmission and with the control of such a feed mixer drivetrain.

### BACKGROUND

The present disclosure generally relates to a feed mixer drivetrain for transmitting power to a feed mixer connected to the PTO (Power Take-Off) connection of an agricultural of industrial vehicle, i.e. a work vehicle, the vehicle comprising a prime mover, generally in the form of Internal combustion engines (ICE) and ground drive wheels driven by main or traction drive transmission.

Present day work vehicles also comprise ICE that can be electronically controlled and that may supply operational data to a controller, in an effort to provide optimum performance and fuel efficiency.

The present invention is directed to a feed mixer drivetrain, to the control of such a drivetrain and to methods of operating thereof.

### BRIEF DESCRIPTION OF THE DRAWINGS

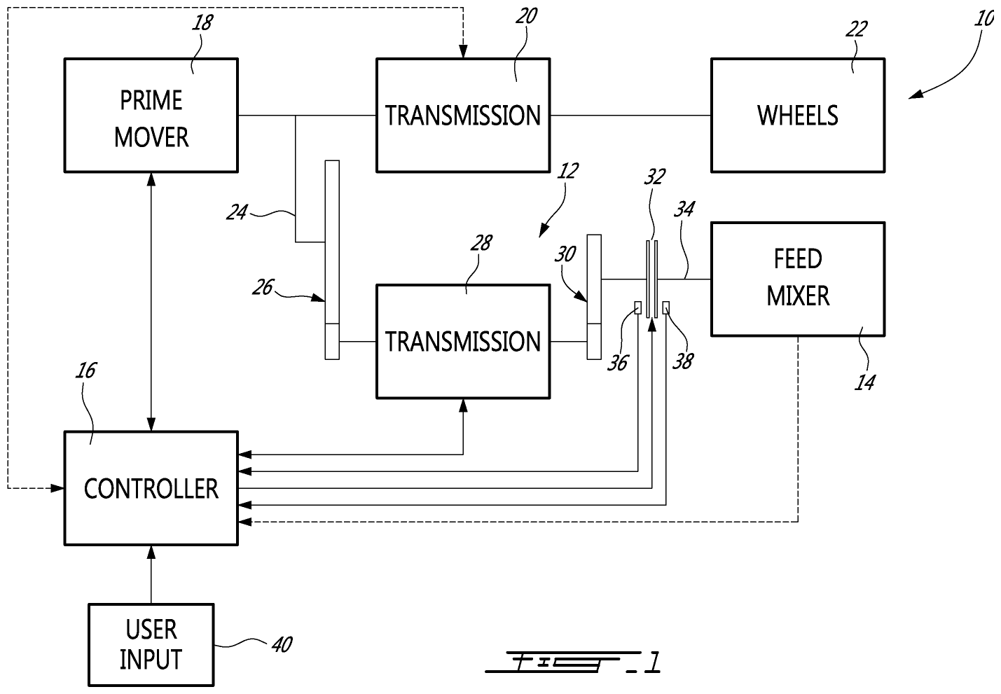

In the appended drawings, FIG. 1 is a schematic view of a drive train including a feed mixer drivetrain provided with a transmission according to an illustrative embodiment.

### DETAILED DESCRIPTION

An object is generally to provide a feed mixer drivetrain including a transmission and methods of control and operation thereof.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

It is to be noted that the expression “prime mover” is to be construed herein and in the appended claims as an internal combustion engine a turbine engine, an electric traction motor or any other mechanical power production element or assembly.

It is to be noted that while the expression “CVT”, standing for Continuously Variable Transmission is to be construed, herein and in the appended claims as any type of Continuously variable transmission including, amongst others dual-cavity full toroidal CVT, half-toroidal CVT; single cavity toroidal CVT, Variable-diameter pulley CVT, Magnetic CVT, Ratcheting CVT, hydrostatic CVT, Cone CVT and planetary CVT. It is also to be noted that the term “CVT” is also to be construed, herein and in the appended claims, as a CVT provided with further elements allowing it to operate as an IVT, standing for Infinitely Variable Transmission, a subset of CVT designs in which the range of ratios of output shaft speed to input shaft speed includes a zero ratio.

It is to be noted that the expression “overdrive” when used herein in the context of a transmission, is to be construed herein and in the appended claims as a condition where the transmission ratio is such that the transmission output speed is higher than the transmission input speed.

It is to be noted that the expression “underdrive” when used herein in the context of a transmission, is to be construed herein and in the appended claims as a condition where the transmission ratio is such that the transmission output speed is lower than the transmission input speed.

It is to be noted that the term “drivetrain”, used herein and in the appended claims, are to be construed as the intervening mechanism by which power is transmitted from a prime mover to a final drive as well as this mechanism plus the prime mover.

The expressions “connected” and “coupled” are interchangeable and should be construed herein and in the appended claims broadly so as to include any cooperative or passive association between mechanical parts or components. For example, such parts may be assembled together by direct coupling or connection, or indirectly coupled or connected using further parts in between. The coupling and connection can also be remote, using for example a magnetic field or else.

The expression “input”, without reference to a specific component such as a shaft, should be construed herein and in the appended claims, as including any movable part of an object, an assembly, a system or a mechanism that is used to receive a mechanical work from same or from another assembly, system or mechanism. Similarly, the expression “output” should be construed as including a similar part that is used to transfer a mechanical work.

The expression “gear ratio” should be construed herein and in the appended claims broadly as meaning the ratio between the speed of rotation at the input of a machine, system or assembly to that of the output thereof.

Other objects, advantages and features of the feed mixer drivetrain provided with a transmission and control method therefor will become more apparent upon reading of the following non-restrictive description of illustrative embodiments thereof, given by way of example only with reference to the accompanying drawings.

Generally stated, the illustrative embodiment describes a feed mixer drivetrain including a transmission and a method for controlling such a feed mixer drivetrain so that the feed is adequately mixed at adequate speed during an adequate time. According to some embodiments of the control method, the actual engine power of the prime mover is taken into account to limit the power supplied to the main vehicle transmission should the actual engine power reach a threshold to thereby decrease the likelihood of the prime mover stalling.

For concision purpose, the following description describes a work vehicle drivetrain 10 having a feed mixer drivetrain provided with a Continuously Variable Transmission (hereinafter referred to as “CVT”) as its transmission. One skilled in the art will understand that this CVT transmission could be replaced by a multi-speed transmission that can be controlled electrically by a controller, as will be apparent by the following description.

FIG. 1 of the appended drawings schematically illustrates a work vehicle drivetrain 10, a feed mixer drivetrain 12, a feed mixer 14 and a controller 16.

The work vehicle drivetrain 10 includes a prime mover, in the form of an ICE 18, having an output shaft connected to the input of a drive transmission 20. The output of the drive transmission 20 is connected to the wheels 22 of the vehicle. The drivetrain 10 also includes a PTO shaft 24 allowing supplemental implements to be driven by the ICE 18.

Of course, one skilled in the art will understand that the drivetrain 10 is schematically illustrated in FIG. 1 and that other elements of the drivetrain 10, interesting for the operation of the vehicle, such as clutches, differentials and the like are not illustrated.

The feed mixer drivetrain 12 includes a first gear set 26 having an input connected to the PTO shaft 24 and an output, a transmission, in the form of a CVT 28, having an input connected to the output of the first gear set 26 and an output, a second gear set 30 having an input connected to the output of the CVT 28 and an output, a clutch 32 having an input connected to the output of the second gear set 30 and an output defining the output of the feed mixer drivetrain 12. The drivetrain 12 also includes first and second speed sensors 36, 38 that respectively detect the speed of the input and output of the clutch 32.

One skilled in the art will understand that the purpose of the first gear set 26 is to increase the rotation speed of the input of the CVT 28 with respect to the rotation speed of the PTO shaft 24 so as to decrease the torque seen by the CVT. As a non-limiting example, the gear ratio of the first gear set 26 can be about 0.4:1.

Similarly, one skilled in the art will understand that the purpose of the second gear set 30 is to slow down the rotation speed at the output of the feed mixer drivetrain with respect to the output of the CVT 28. For example, a gear ratio of about 5:1 can be used.

Gear sets having ratios as mentioned above are interesting for a feed mixer drivetrain having an input speed of about 1000 RPM where the ratio range of the CVT varies from about 2.15:1 to about 0.40:1 and where the desired output ranges from about 250 RPM to about 1200 RPM.

For other particular drivetrains and desired output speed ranges, one skilled in the art will therefore be in a position to determine if any or all of the gear sets 26 and 30 are required and to determine the gear ratios of these gear sets.

The feed mixer 14 includes an input shaft 34 connected to the output of the feed mixer drivetrain 12. Conventionally, the feed mixer 14 includes augers and/or blades allowing the feed inserted therein to be cut and/or mixed.

As mentioned hereinabove, one skilled in the art will be in a position to determine the gear ratio of the gear sets 26 and 30 depending on the rotation speed of the PTO shaft of the ICE 18, the variable ratio range of the CVT 28 and the desired range of speed of the feed mixer 14.

The controller 16 includes a user input 40 and connections to the prime mover 18, the CVT 28, the speed sensors 36, 38, to the clutch 32 and optionally to the feed mixer 14 and to the drive transmission 20.

The connection between the controller 16 and the ICE 18 allows the controller 16 to receive data about the rotational speed of the output shaft of the ICE 18 and optionally about the actual engine power developed by the ICE 18. Optionally, the controller 16 can override commands given to the ICE 18 by the user, as will be described hereinbelow.

One skilled in the art will understand that should the ICE 18 not be adequate to supply this type of data to the controller 16, separate sensors such as speed sensors and/or power sensors (not shown) could be used.

The connection between the controller 16 and the CVT 28 allows the controller 16 to control the ratio of the CVT 28. Often, CVTs are provided with integrated input and output speed sensors and other sensors such as temperature sensors and the like (all not shown). When this is the case, the data from these sensors can be supplied to the controller 16. Accordingly, the controller, receiving data from the input and output speed sensors, can determine the instantaneous speed ratio of the CVT as a feedback to ensure that the ratio requested is reached.

The connection between the controller 16 and the clutch 32 allows the controller 16 control the engagement and disengagement of the clutch 32.

The controller 16 receives speed data from the speed sensors 36 and 38 to allow the controller 16 to determine if the clutch 32 is slipping. One skilled in the art will understand that should the CVT 28 be equipped with integrated output speed sensors (not shown), the speed sensor 36 could be omitted. One skilled in the art will also understand that other means could be used to detect the slippage condition of the clutch.

The optional connection between the controller 16 and the feed mixer 14 allows the controller 16 to receive data about the power consumed by the operation of the feed mixer 14. Should the feed mixer 14 not be equipped to supply this data to the controller 16, separate sensors (not shown) could be used.

Finally, the optional connection between the controller 16 and the drive transmission 20 allows the controller 16 to override commands given to the transmission 20 by the user as will be described hereinbelow. Similarly, the transmission 20 could override commands given by the controller 16.

One skilled in the art will understand that the clutch 32 could be positioned upstream from the CVT 28.

One skilled in the art will understand that the controller 16 may be part of a main controller (not shown) of the vehicle used, amongst others, to control the prime mover 18 and the transmission 20.

One skilled in the art will also understand that the main transmission 20 of the drivetrain 10 can also be a CVT.

### FIRST EXAMPLE OF THE FEED MIXER DRIVETRAIN CONTROL

According to this first example of a feed mixer drivetrain control, a sequence of speed and duration of mixing is selected depending on the nature of feed supplied to the feed mixer. Generally, the sequence will include multiple operation phases such as an engagement phase, a ramp-up phase, a mixing phase, a discharging phase and a cleaning phase. The speed and duration of each of these phases may vary depending on the type of feed and the size of the load.

As a non-limiting example, here are speed and time for the operation phases when a typical load including both grain feed and baled feed is to be mixed in a feed mixer:

1—Engagement phase: from 0 to about 233 rpm (ramp of about 3 seconds);

2—Ramp-up phase: from about 233 to about 700 rpm (ramp of about 30 seconds);

3—Mixing phase: from about 700 to about 1000 rpm (Duration from about 5 to about 15 minutes);

4—Discharging phase: about 700 rpm (Duration depending on the size of the load); and

5—Cleaning phase: about 1200 rpm (for about 30 seconds).

It is to be noted that the rotational speed supplied to the input 34 of the feed mixer 14 may be finely tuned by the controller 16, since a CVT transmission is used. Similarly, the use of a CVT allows the rotational speed of the ICE 18 to be changed while the feed mixer 14 is in use. In other words, the controller 16 controls the CVT 28 so that it may compensate for the changes in the rotational speed of the ICE 18, should such change of speed occur.

One skilled in the art will understand that the engagement and ramp-up phases are interesting when baled feed is present since more power is required to start up the feed mixer and that more power is available when the CVT ratio is in the underdrive portion of its range.

One skilled in the art will also understand that should no baled feed be present in the feeds to be mixed, the duration of the engagement phase and of the ramp-up phase could be reduced.

The controller 16 includes a memory that can store a plurality of such sequences in a manner allowing the user to select a desired sequence and allowing the controller to control the CVT 28 and prime mover 18 so as to provide the desired rotation speed to the feed mixer 14 with sufficient power for the feed mixer to operate properly while allowing power to be supplied to the wheels 22 via the transmission 20.

One skilled in the art will understand that, optionally, the controller 16 may be so configured to allow the user to shorten or to extend any of the phases, via the user input should the user determine that the phase needs less or more time to properly perform the particular phase.

It is to be noted that during any phase described above, should the controller 16 detect that the clutch 32 is slipping, by receiving different speeds from the speed sensors 36 and 38, the controller 16 disengages the clutch 32 to prevent potential damage to the feed mixer 14. The controller then decreases the CVT ratio so that the rotational speed of its output is reduced and engages the clutch 32. Should the clutch 32 slip again, the user is warned, and the system awaits further user input.

Of course, other scenarios could be designed to prevent damage to the feed mixer 14 should the controller 16 detect that the clutch 32 slip.

### SECOND EXAMPLE OF FEED MIXER DRIVETRAIN CONTROL

This second example of feed mixer drivetrain control is similar to the first example described hereinabove, but in this second example, the timing of the various phases can partially be determined by the power consumed by the feed mixer.

More specifically, in this second example, the mixing phase has a minimum duration to ensure proper mixing, but the actual duration of the mixing phase is determined by the power consumed by the feed mixer. Indeed, while the augers and/or blades of the feed mixer are used to unbale and cut the baled feed (such as hay) more power is consumed by the feed mixer.

Therefore, when the controller 16 detects that the power consumed by the feed mixed 14 decreases significantly, from the power data supplied to the controller by the feed mixer, it may determine that an adequate duration of the mixing phase has occurred. When this is the case, the feed mixer drivetrain is ready for the discharging phase.

### THIRD EXAMPLE OF FEED MIXER DRIVETRAIN CONTROL

It this third example, at least the discharging phase is done while the work vehicle is in movement. When this is the case, the actual engine power from the ICE 18 is monitored by the controller 16.

Since the controller 16 may also receive the actual engine power developed by the prime mover 18, generally in the form of a percentage of the maximal engine power, the controller 16 knows when the prime mover 18 is close to reach its limits and risks stalling.

As will be apparent to one skilled in the art, obtaining the actual engine power of the prime mover 18 is simple since the prime mover 18 is in communication with the controller 28 as can be seen in FIG. 1. Without limitations, a conventional CAN bus (Controller Area Network) can be used to interconnect the various elements.

Should the controller 16 determine that the actual engine power is close to reach its limits and risks stalling, the power supplied to the transmission 20 to drive the wheels 22 may be decreased to ensure that the ICE 18 does not stall. Indeed, since the actual engine power is the sum of the power supplied to the transmission 20 and the power supplied to the feed mixer drivetrain 12, by lowering the power supplied to the transmission 20, the power required to adequately supply the feed mixer 14 may be supplied thereto without the ICE 18 stalling.

In other words, the controller 16 may override the commands of the user regarding the speed of the vehicle.

Alternatively, the controller 16 could warn the user that power to the transmission 20 is about to be reduced. This allows the user to override the commands should it be necessary for safety or other reasons. Accordingly, the commands of the controller 16 can be overridden by the user. As a non-limiting example, should a mixing phase occur during a relatively long travel of the vehicle, the user could determine that priority should be given to the drive transmission 20 of the vehicle since the mixing phase may be lengthened without prejudice.

It is to be noted that other data can be supplied to the controller 16 in order for the controller to determine if a power decrease is in order. For example, a GPS (not shown) can supply terrain slope data to the controller so as to help the controller determine the duration required to go up a hill and therefore determine is the maximal allowable power on the prime mover 18 will be reached and control the CVT ratio accordingly.

Similarly, data coming from accelerometers and/or tilt or slope sensors and/or other types of terrain sensors (all not shown) can be supplied to the controller to help in the control the CVT ratio.

One skilled in the art will understand that while the feed mixer drivetrain 12 has been illustrated herein and described hereinabove as being separate both from the work vehicle and from the feed mixer 14, the feed mixer driveline 12 could be integrated with one or the other of these elements.

Also, one skilled in the art will understand that the user input 40 may be wireless.

It is to be understood that the feed mixer drivetrain provided with a CVT and control method therefor is not limited in its application to the details of construction and parts illustrated in the accompanying drawings and described hereinabove. The feed mixer drivetrain provided with a CVT and control method therefor is capable of other embodiments and of being practiced in various ways. It is also to be understood that the phraseology or terminology used herein is for the purpose of description and not limitation. Hence, although the feed mixer drivetrain provided with a CVT and control method therefor has been described hereinabove by way of illustrative embodiments thereof, it can be modified, without departing from the spirit, scope and nature thereof.

The following numbered clauses are offered as further description:

1. A feed mixer drivetrain connectable to an output shaft of a prime mover and to the input shaft of a feed mixed, the feed mixer drivetrain comprising:

a transmission having an input connectable to the output shaft of the prime mover and an output connectable to the input shaft of the feed mixer; and

a controller so associated with the transmission as to control a sequence of operation phases of the feed mixer; each operation phase defining a predetermined speed of the input shaft of the feed mixer via the transmission and a predetermined duration.

2. A feed mixer drivetrain as recited in clause 1, wherein the transmission is a multi-speed transmission

3. A feed mixer drivetrain as recited in clause 1, wherein the transmission is a Continuously Variable Transmission (CVT).

4. A feed mixer drivetrain as recited in any of the previous clauses, wherein the output of the transmission is connectable to the input shaft of the feed mixer via a clutch.

5. A feed mixer drivetrain as recited in any of the previous clauses, wherein the input of the transmission is connectable to the output shaft of the prime mover via a first gear set.

6. A feed mixer drivetrain as recited in any of the previous clauses, wherein the output of the transmission is connectable to the input shaft of the feed mixer via a second gear set.

7. A feed mixer drivetrain as recited in any of clauses 4 to 6, further comprising first and second speed sensors respectively associated with an input and an output of the clutch and so connected to the controller as to supply speed data thereto; the controller being so configured as to detect a slipping condition of the clutch.

8. A feed mixer drivetrain as recited in any of the previous clauses, wherein the controller is so associated with the prime mover as to receive speed data therefrom.

9. A feed mixer drivetrain as recited in clause 8, wherein the controller is so associated with the prime mover as to receive actual torque data therefrom.

10. A feed mixer drivetrain as recited in any of the previous clauses, further comprising a speed sensor associated with the output shaft of the prime mover and supplying speed data to the controller, wherein the controller is so configured as to determine the actual engine power from the speed data.

11. A feed mixer drivetrain as recited in any of the previous clauses, wherein the controller is so associated with the feed mixer as to receive power consumed data therefrom.

12. A feed mixer drivetrain as recited in any of the previous clauses, further comprising a user input associated with the controller and wherein the controller includes a memory so configured as to store a plurality of sequences of operation phases and to allow the user to select a desired sequence.

13. A feed mixer drivetrain as recited in any of the previous clauses, wherein the sequence of operation phases includes at least two operation phases selected from the group consisting of an engagement phase, a ramp-up phase, a mixing phase, a discharge phase and a cleaning phase. 14. A PTO drive as recited in clause 1 further including a terrain sensor connected to the controller.

15. A method for controlling a feed mixer drivetrain having an input connected to the output shaft of a prime mover, the feed mixer drivetrain including a transmission having a variable speed ratio and an output to which a feed mixer input may be connected, and a controller having a user input and being so connected to the transmission as to control the speed ratio thereof, the method comprising:

selecting a sequence of operation phases from a plurality of sequences; each sequence including at least two operation phases each defining a predetermined speed of the output of the feed mixer drivetrain and duration of the operation phase;

controlling the transmission so as to apply the at least two operation phases of the selected sequence.

16. A method as recited in clause 15, wherein the at least two sequences are selected from the group consisting of an engagement phase, a ramp-up phase, a mixing phase, a discharge phase and a cleaning phase.

17. A method as recited in any of the clauses 15 and 16, wherein the feed mixer drivetrain includes a clutch provided between the transmission output and the feed mixer input, the clutch being engaged and disengaged by the controller; the method comprising disengaging the clutch should the controller detect a slippage of the clutch.

18. A method as recited in any of the clauses 15 to 17, wherein the clutch includes an input and an output and wherein the feed mixer drivetrain includes first and second speed sensors each associated with a respective one of the input and output of the clutch; the speed sensors being so connected to the controller as to supply speed data thereto.

What is claimed is:

1. A feed mixer drivetrain connectable to an output shaft of a prime mover and to the input shaft of a feed mixed, the feed mixer drivetrain comprising:
a transmission having an input connectable to the output shaft of the prime mover and an output connectable to the input shaft of the feed mixer; and
a controller so associated with the transmission as to control a sequence of operation phases of the feed mixer; each operation phase defining a predetermined speed of the input shaft of the feed mixer via the transmission and a predetermined duration.

2. A feed mixer drivetrain as recited in claim 1, wherein the transmission is a multi-speed transmission

3. A feed mixer drivetrain as recited in claim 1, wherein the transmission is a Continuously Variable Transmission (CVT).

4. A feed mixer drivetrain as recited in claim 1, wherein the output of the transmission is connectable to the input shaft of the feed mixer via a clutch.

5. A feed mixer drivetrain as recited in claim 1, wherein the input of the transmission is connectable to the output shaft of the prime mover via a first gear set.

6. A feed mixer drivetrain as recited in claim 1, wherein the output of the transmission is connectable to the input shaft of the feed mixer via a second gear set.

7. A feed mixer drivetrain as recited in claim 4, further comprising first and second speed sensors respectively associated with an input and an output of the clutch and so connected to the controller as to supply speed data thereto; the controller being so configured as to detect a slipping condition of the clutch.

8. A feed mixer drivetrain as recited in claim 1, wherein the controller is so associated with the prime mover as to receive speed data therefrom.

9. A feed mixer drivetrain as recited in claim 8, wherein the controller is so associated with the prime mover as to receive actual torque data therefrom.

10. A feed mixer drivetrain as recited in claim 1, further comprising a speed sensor associated with the output shaft of the prime mover and supplying speed data to the controller, wherein the controller is so configured as to determine the actual engine power from the speed data.

11. A feed mixer drivetrain as recited in claim 1, wherein the controller is so associated with the feed mixer as to receive power consumed data therefrom.

12. A feed mixer drivetrain as recited in claim 1, further comprising a user input associated with the controller and wherein the controller includes a memory so configured as to store a plurality of sequences of operation phases and to allow the user to select a desired sequence.

13. A feed mixer drivetrain as recited in claim 1, wherein the sequence of operation phases includes at least two operation phases selected from the group consisting of an engagement phase, a ramp-up phase, a mixing phase, a discharge phase and a cleaning phase.

14. A PTO drive as recited in claim 1 further including a terrain sensor connected to the controller.

15. A method for controlling a feed mixer drivetrain having an input connected to the output shaft of a prime mover, the feed mixer drivetrain including a transmission having a variable speed ratio and an output to which a feed mixer input may be connected and a controller having a user input and being so connected to the transmission as to control the speed ratio thereof, the method comprising:
selecting a sequence of operation phases from a plurality of sequences; each sequence including at least two operation phases each defining a predetermined speed of the output of the feed mixer drivetrain and duration of the operation phase;
controlling the transmission so as to apply the at least two operation phases of the selected sequence.

16. A method as recited in claim 15, wherein the at least two sequences are selected from the group consisting of an engagement phase, a ramp-up phase, a mixing phase, a discharge phase and a cleaning phase.

17. A method as recited in claim 15, wherein the feed mixer drivetrain includes a clutch provided between the transmission output and the feed mixer input, the clutch being engaged and disengaged by the controller;
the method comprising disengaging the clutch should the controller detect a slippage of the clutch.

18. A method as recited in claim 17, wherein the clutch includes an input and an output and wherein the feed mixer drivetrain includes first and second speed sensors each associated with a respective one of the input and output of the clutch; the speed sensors being so connected to the controller as to supply speed data thereto.
